(19) United States
(12) Patent Application Publication
(10) Pub. No.: US 2015/0178396 A1
(43) Pub. Date: Jun. 25, 2015

(54) Metadata Database System and Method

(71) Applicant: Projectioneering LLC, Frederick, MD (US)

(72) Inventor: John H. Hnatio, Union Bridge, VA (US)

(21) Appl. No.: 14/537,605

(22) Filed: Nov. 10, 2014

Related U.S. Application Data
(63) Continuation of application No. 13/653,189, filed on Oct. 16, 2012, now abandoned.
Application No. 13/653,189 is a continuation of application No. 12/948,588, filed on Nov. 17, 2010, now abandoned.

(51) Int. Cl. G06F 17/30; G06N 5/02

(52) U.S. Cl. CPC G06F 17/30867; G06F 17/3053; G06N 5/022

(57) ABSTRACT

Systems, methods and computer readable media for computerized control and management of a metadata database. The metadata database can include event data, standards, survey questions and response, and event response templates. Event projection can be based on data retrieved from a past events database. Control can include real-time control of subsystems within the complex system and providing reports and visualizations. The visualizations can include profile graphs, bar graphs, dashboards and hyperbolic mapping.

### FIELD OF THE INVENTION

Embodiments relate generally to computerized database management and, more particularly, to systems, methods and computer readable media for management of a metadata database adapted for storage and retrieval of risk or threat event data.

### BACKGROUND

A risk or threat event such as an outbreak of a communicable disease, food-borne illness or terrorist attack may be difficult to identify at an early stage. This difficulty may lead to a delay in the identification and response to the event. Also, in order to provide a scientifically derived alternative to the continued reliance on conventional techniques for managing risk in complex systems or events, a metadata database may be needed. The metadata database can combine data from multiple sources into a single, non-relational database, for example.

A robust approach to managing risk in complex events or systems may require integration of quantitative scientific information with qualitative human social processes in a way that provides a more effective management technique. Because of the large quantities of data typically associated with complex events or systems, a computerized method, system and computer readable medium for management of a metadata database can provide the data storage and retrieval functions for a complex event management system.

### SUMMARY

One embodiment includes a computer-based system for managing a metadata database, the computer-based system having a processor coupled to a data storage device, and an interface adapted to exchange data with another device. The data storage device having stored thereon a metadata database having event data, a standards library, survey questions, survey answers, a survey scoring system and event response templates. The data storage device also having software instructions stored thereon that, when executed by the processor, cause the processor to perform operations. The operations include automatically acquiring event data from a plurality of event data sources accessed via the interface, and storing the acquired event data in the metadata database. The operations also include automatically acquiring standards data from a plurality of standards data sources accessed via the interface, and storing the acquire standards data in the metadata database. The operations further include automatically acquiring survey response data and scoring the survey response data according to a scoring system retrieved from the metadata database in order to generate a survey score. The operations also include storing the acquired survey response data and the survey score in the metadata database, updating risk values retrieved from the metadata database according to the acquired survey response data, storing the updated risk values in the metadata database and providing a risk assessment output based on the updated risk values retrieved from the metadata database.

### BRIEF DESCRIPTION OF THE DRAWINGS

FIG. 1 is a diagram of a computerized event assessment, projection and control system having a knowledge engine coupled to a metadata database in accordance with the present disclosure.

FIG. 2 is a diagram of a metadata database structure in accordance with the present disclosure.

FIG. 3 is a diagram of past and/or simulated event data in accordance with the present disclosure.

FIG. 4 is a diagram of a standards library in accordance with the present disclosure.

FIG. 5 is a diagram of survey questions, answers and scoring data in accordance with the present disclosure.

FIG. 6 is a diagram of response templates and information in accordance with the present disclosure.

FIG. 7 is a diagram of an automatic data acquisition system in accordance with the present disclosure.

FIG. 8 is a diagram of a survey response acquisition system in accordance with the present disclosure.

FIG. 9 is a chart showing a method of automatic data acquisition, in accordance with the present disclosure.

FIG. 10 is a chart showing a method of survey data acquisition in accordance with the present disclosure.

FIG. 11 is a chart showing a method of metadata database retrieval method in accordance with the present disclosure.

FIG. 12 is a chart showing a method for computerized learning in accordance with the present disclosure.

### DETAILED DESCRIPTION

While embodiments may be described in connection with various specific application examples, it will be appreciated that the methods, systems and computer readable media disclosed herein are applicable to many types of facilities, organizations, processes, scenarios and the like. For example, the metadata database management methods, systems and computer readable media disclosed herein can be applied to schools, buildings, biotechnology production, food services (growing, production, distribution and handling), transportation, military facilities, other sensitive facilities where security may be a concern, hospitals, airports, businesses, financial institutions and the like. In general, the techniques, systems and software disclosed herein can be applied to any complex system for which a metadata database for storage and retrieval of risk assessment data, event projection data and/or event response control data may be desired.

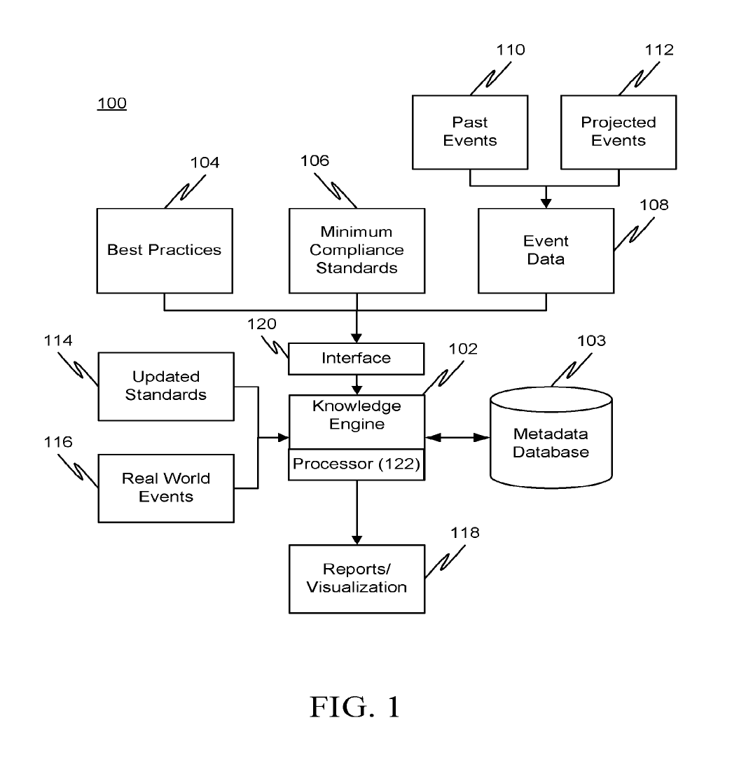

FIG. 1 shows a diagram of a computerized event assessment, projection and control system having a knowledge engine and a metadata database in accordance with the present disclosure. The assessment system 100 includes (i.e., comprises) a knowledge engine 102 (having a processor 122) and being coupled to a metadata database 103 (e.g., a data storage device). The knowledge engine 102 is adapted to receive, via an interface 120, best practices 104, minimum compliance standards 106 and event data 108 from one or more external systems via a computer network. The event data 108 can include data relating to and/or describing past events 110 and projected events 112. The knowledge engine can also receive and process data including updated standards 114 and real world events 116.

The various inputs are statistically processed in the knowledge engine 102 along with optional data gathered from online user surveys. The online survey data can be gathered via a web service interface, email response, or the like. The online survey data can include answers to questions about general and/or specific procedures and processes of an organization. These answers are numerically scored in order to quantify the response for later use in calculating risk.

The knowledge engine 102 outputs reports and/or graphical visualizations 118. The reports can include a level of the practices being implemented for risk events and can also indicate a capability for each risk event or risk event category. Data used to generate the reports and visualizations is retrieved from the metadata database 103.

The knowledge engine 102 can be adapted to be a learning knowledge engine in that new event data, standards, best practices and minimum compliance standards, actual internal data and/or actual external data can be continuously and automatically added to the metadata database 103. The automatically collected data can be automatically evaluated, categorized, reverse engineered and/or triangulated. In general, triangulation is the application and combination of multiple research methodologies in the study of the same phenomenon. Instead of relying on a single form of evidence or perspective as the basis for findings, multiple forms of diverse and redundant types of evidence are used to check the validity and reliability of the findings. For example, in the case of risk event categories, risk events are triangulated by grouping like events together under a single category such as arson or natural disaster. Also, in another example, triangulation, in the case of a standards library, can include identifying a set of categories for the standards and a minimum set of items or process steps in each category that would satisfy the various constituents of the standards library. For example, in the food processing industry, one category of standard may relate to worker health and cleanliness. Data can be automatically collected through such mechanisms as web crawlers and bots designed to collect specific types of information from previously known and/or newly discovered sources. Data may also be automatically collected via feed mechanisms such as RSS and/or through a web services-type interface between the knowledge engine 102 and one or more external systems. Through a machine learning mechanism, the knowledge engine 102 can adapt over time to changing risk categories and events and may become more accurate over time with respect to known events by virtue of an increasing number of data points from which to base assessments, projections, simulations and responses.

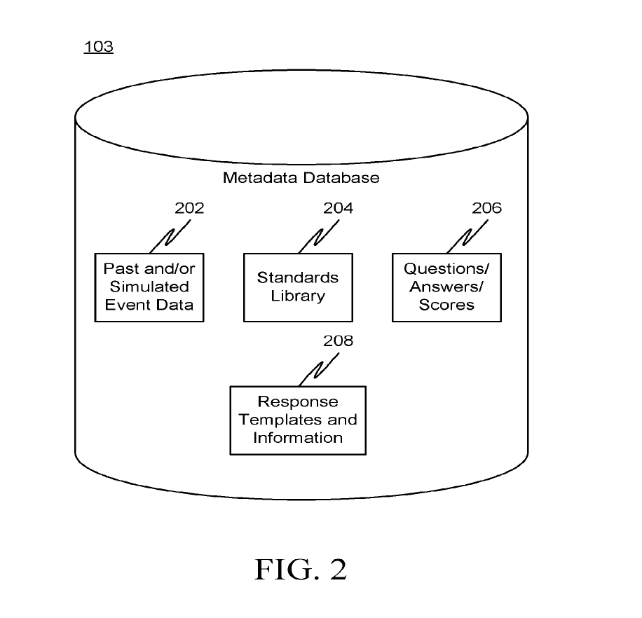

FIG. 2 is a diagram of a metadata database structure in accordance with the present disclosure. The metadata database 103 can contain past and/or simulated event data 202, a standards library 204, questions/responses/scoring information 206, and response templates and information 208.

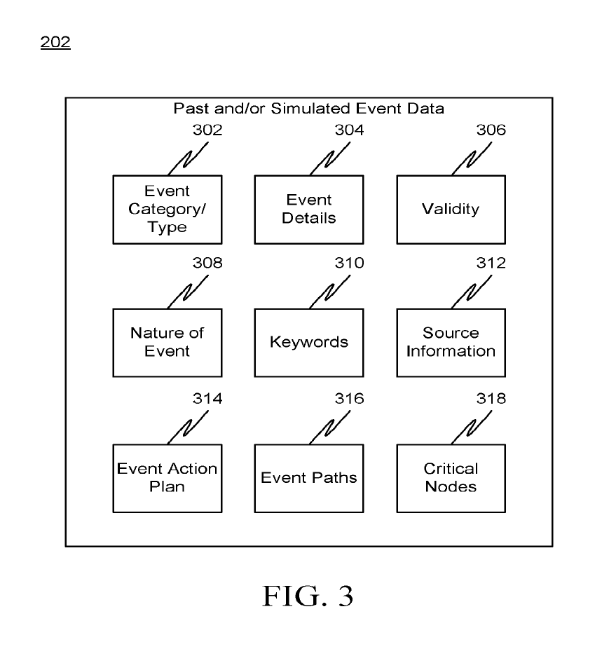

The past and/or simulated event data 202 can include data describing one or more risk or threat events. For example, in a school setting the risk event categories can include mass shooting and/or hostage taking, food adulteration, improvised destructive devices, fire and arson, transportation safety, nuclear, biological and chemical (NBC) emergencies, other on-campus crimes, suicide, communicable disease, natural disasters, and the like. Specific events can be grouped or triangulated into groups associated with a common risk event category. The past and/or simulated event data 202 is described in greater detail below in connection with FIG. 3.

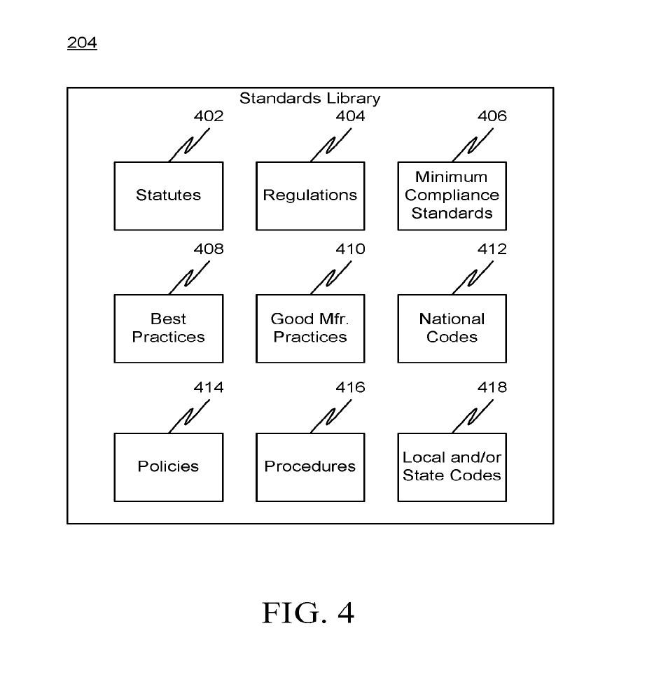

The standards library 204 can include federal, state and/or local rules, regulations, statutes and the like; local and/or national codes; national standards (e.g., ANSI); best industry practices; policies, procedures and processes internal to an organization, entity or facility; good manufacturing practices; and/or the like. The standards library 204 is described in greater detail below in connection with FIG. 4.

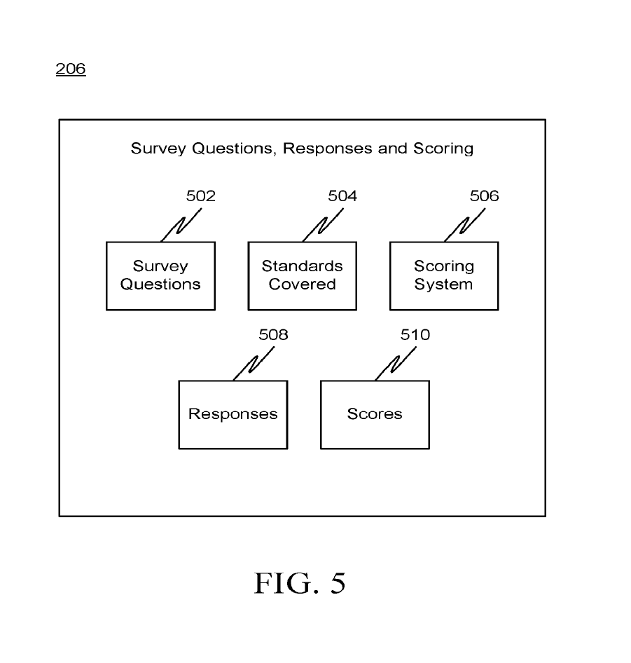

The questions, responses and scoring data 206 can include questions for assessing an organizations risk level. The responses can be provided by organization personnel and numerically scored to generate scoring data. The questions, responses and scoring data 206 are discussed below in connection with FIG. 5.

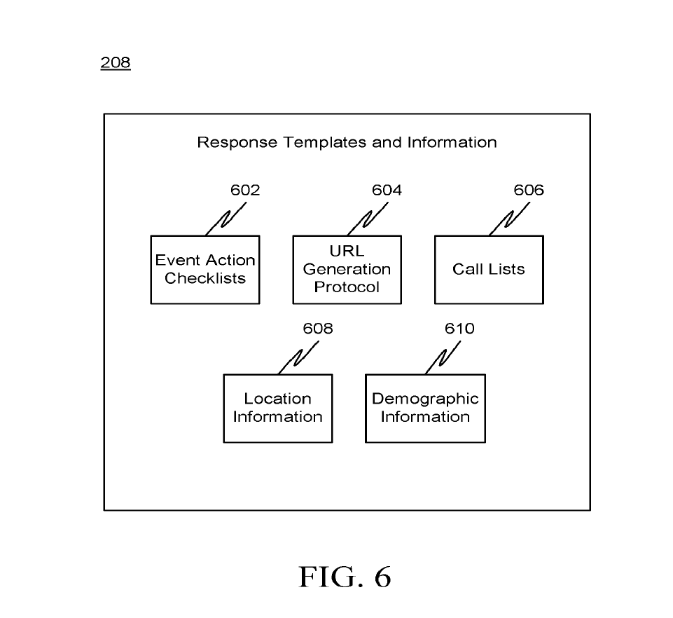

The response templates and information 208 includes information for responding to a risk (or threat) event that is in progress or has already occurred. The response templates and information 208 is discussed below in connection with FIG. 6.

The metadata database 103 can include data in a non-relational (e.g., flat file) database structure. The database structure can include records (or rows) with an “infinite” (or expandable) number of fields or field lengths. The flat file and infinite records are important because they permit an embodiment to provide search capabilities across some or all fields and some or all records. This capability can overcome a possible limitation of relational databases when considering complex events. A relational database typically contains information in separate, related tables. If the correct field is not searched, it is possible in a relational database structure to miss connections between data items or to potentially overlook a record simply because the necessary relational value was not correctly queried. Thus, a relational database may be more rigid in the sense that all of the data must fit into one of the tables, whereas in the flat file, “infinite” record structure metadata database disclosed herein, the entire database is searchable and connections between a search term and a possible event may be more likely to be revealed, for example. Also, the flat database structure can permit data to be extracted from different fields to create and/or change pattern-based (e.g., by comparing and contrasting event sequences) and/or statistical relationships dynamically without a need to alter relational tables or structures. The metadata database can permit data to be processed, organized, stored and retrieved in a manner that supports quantification of human behaviors by reverse engineering past events into their causal steps and relating human behaviors and the outcomes of those behaviors to each causal step to produce a statistical correlation. The flat structure of the metadata database does not depend on predefined or pre-established hierarchical and/or relational control, relationships between data items can be changed dynamically to accommodate new data being input to the metadata database. Also, the metadata database can support a real-time system by providing for the updating and/or input of data in real time.

FIG. 3 is a diagram of past and/or simulated event data in accordance with the present disclosure. The past and/or simulated event data 202 can include event category/type data 302, event details 304, event data validity 306, a nature of the event 308, keywords 310, source information 312, an event action plan 314, event paths 316 and critical nodes 318.

For example, the event category/type data 302 can include poisoning as an event category and intentional poisonings as a specific event type. The event details 304 can include date, location and a narrative description of the event.

The validity data 306 can include a numerical credibility score or an indication of a validity classification such as confirmed, highly likely, possible, unlikely and known hoax. Confirmed events, for example, could be a classification used for events that have been reported by more than one reliable (or trusted) source such as a government or other authority. The “highly likely” classification could be used for those events reported by a single reliable source. Possible events could be those reported by credible sources. Unlikely events could be those that are reported by potentially unreliable sources such as tabloid magazines or websites, personal blogs or the like. The “known hoax” classification can be used for events that are confirmed and/or known hoaxes.

In a poisoning event database example, the nature of the event 308 can include an indication of whether an event was food related (e.g., biological, chemical or intentional disruption) or other poisoning (e.g., biological gas, chemical gas, burning gas, wounding biological agent, wounding chemical agent or wounding transmission agent). In general, the nature of the event 308 can be used to further classify an event beyond event category and type 302 data.

The keywords 310 can include keywords taken from the event description that would be likely or helpful search terms for future users of the system. For example, in the case of a poisoning event involving ingestion of an unsafe amount of the spice nutmeg, the keywords 310 field may include such terms as date, location, nutmeg, intentional poisoning, overdose, ½ to 1 ounce, hospitalized, and 1 victim.

The source information 312 fields can be used to store the source(s) of the event data. For example, the source information 312 fields can be used to store the uniform resource locator (URL) of a report about an event published online.

The event action plan 314 data can include planning (e.g., description and feasibility fields), resources, execution of plan, vulnerability, consequences and mitigators for each event.

The event paths 316 can include the sequential steps leading up to and following a threat or risk event. For example, in the case of an arson event the event path can include the steps of: 1) threats or threatening behaviors; 2) obtaining accelerant; 3) smuggling accelerant into building; 4) accessing target area; 5) starting fire; 6) leaving area undetected; 7) automatic fire suppression; 8) fire loading; 9) sustainable blaze; 10) fire spread; 11) response; and 12) containment.

The critical nodes 318 can include data representing a vertex or a place where a number of interdependent variables cross one another. The critical node vertexes are those points in a larger system that may be most sensitive to changes because when they are disturbed they have the greatest extended order effects on the larger system. In other words, a critical node can represent a critical aspect of an event sequence or a category of event sequences that, when affected, can increase or decrease the likelihood of the event occurring or the consequences of event escalation. Event escalation can include a cascading system failure. The critical nodes 318 can also include a weighting of each critical node across a threat or risk continuum. The threat (or risk) continuum can include deter, detect, prevent, respond and mitigate phases.

FIG. 4 is a diagram of a standards library in accordance with the present disclosure. The standards library 204 can include statutes 402 (e.g., U.S. Code, state codes, or the like); regulations 404 (e.g., Code of Federal Regulations); minimum compliance standards 406; best practices 408; good manufacturing practices 410; national codes 412; organizational policies 414; organizational procedures 416; and local and/or state codes 418. The standards in the standards library 204 can be triangulated or grouped so that a minimum set of survey questions can be developed that can assess an organization's compliance with the various standards.

FIG. 5 is a diagram of survey questions, answers and scoring data in accordance with the present disclosure. The survey questions, responses and scoring data 206 can include survey questions 502, standards covered 504, a scoring system 506, responses 508 and scores 510.

As discussed above regarding the standards library 204, a minimum set of survey questions 502 can be developed from the triangulated (or grouped) standards such that the survey questions 502 correspond to one or more of the standards. The standards covered 504 are the standards covered by each corresponding question. By correlating a group of standards covered with the question covering that group of standards, the metadata database is able to link compliance with the standards to a particular question or group of questions. This linking of a survey question to a triangulated subset of the standards is important because the distributed, complex system of standards can make it difficult for an organization to determine the applicable standards, which agency or branch of government promulgated the applicable standards and whether the organization is in compliance or not with the applicable standards.

The scoring system 506 is established to generate a quantified value from survey question responses. Because the standards 504 and scoring system 506 are stored in the metadata database, they can be augmented or adjusted to reflect changes in the organization or standards. For example, when a new standard is added, the scoring system can be updated to reflect a score for a new question corresponding to the new standard.

The responses 508 can include responses from survey participants (e.g., organization staff or personnel). The responses can be collected automatically via online surveys, email surveys, or the like.

The scores 510 can be generated by the knowledge engine and stored in the metadata database. The scores 510 are based on the responses 508 and scoring system 506. For example, a yes response to a question may be worth 5 points, while a no response is worth zero points. The individual question point values can be added to arrive at an overall score. The survey questions and scoring can be grouped into general questions and/or specific area questions (e.g., food safety, facilities, emergency response preparedness, or the like).

FIG. 6 is a diagram of response templates and information in accordance with the present disclosure. The response templates and information 208 can include event action checklists 602, a URL generation protocol 604, one or more call lists 606, location information 608 and demographic information 610.

The event action checklists 602 can include a sequence of actions for an organization to take when a particular event occurs. For example, a metadata database system adapted for a school campus environment may store checklists for events such as a fire emergency, chemical spill emergency, hostage taking/shooting, or the like. Each threat or risk event can have an associated event action checklist stored in the metadata database.

The URL generation protocol 604 can include information specifying how an emergency URL is to be generated when a risk or threat event occurs. The emergency URL is a single-use, randomly generated URL that can be accessed by first responders, organization personnel, police, or the like to keep abreast of an event in progress.

The call lists 606 can include names, phone numbers and email addresses for people or organizations that are to be notified when a risk or threat event occurs. The lists can be organized according to event category (e.g., fire, natural disaster, communicable disease, or the like).

The location information 608 can include the physical location information of a facility, building, campus or the like. The physical location can be an address and/or geographical coordinates. Also, within an overall location, sub-locations may be specified. For example, a university campus may have an overall location along with location information for individual buildings on campus.

The demographic information 610 can include information that may be useful for responding to a threat or risk event, such as, number of people present, size/capability of any on-site first response team, or the like.

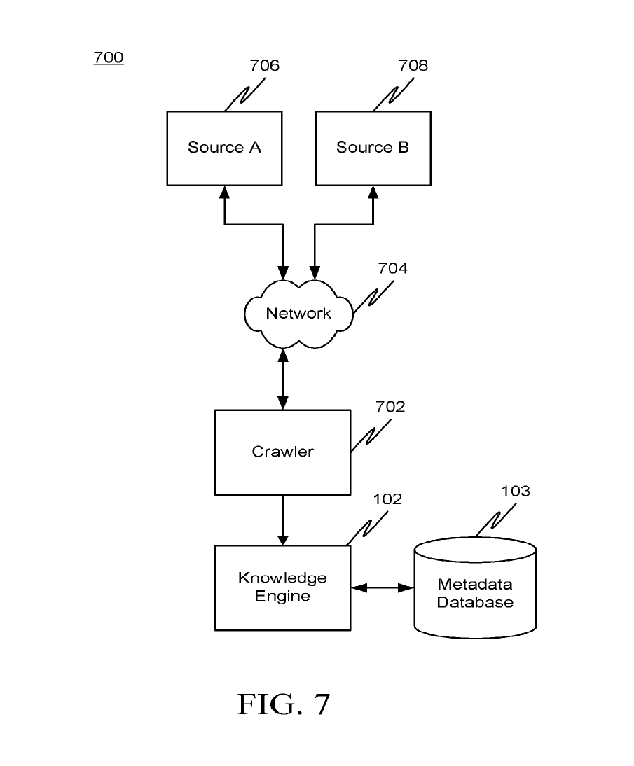

FIG. 7 is a diagram of an automatic data acquisition system 700 in accordance with the present disclosure. The automatic data acquisition system 700 includes a crawler 702 coupled to the knowledge engine 102 and the metadata database 103.

The crawler 702 is a program executing on a processor that visits Web sites and reads their pages and other information in order to obtain data for the metadata database. A crawler is also known as a “spider” or a “bot.” The crawler 702 can be programmed to visit sites from a predetermined list of sites. Entire sites or specific pages can be selectively visited and indexed. The crawler can also follow links to other pages on a site until all pages from that site have been read.

The crawler 702 communicates, via a network 704, with one or more sources 706, 708. The network 704 can include any wired or wireless network such as a local area network (LAN), wide area network (WAN), the Internet, or the like. The sources 706, 708 can be websites, file transfer protocol (FTP) sites, RSS feeds, web services and/or the like. In a situation where a crawler 702 is adapted to access FTP sites, RSS feeds and web services, the crawler 702 can include specialized interfaces for each protocol.

In operation, data retrieved by the crawler 702 can be used to create new entries in the metadata database 103 or to modify existing entries in the metadata database 103. For example, the crawler 702 can be adapted to visit emergency event sites to gather data about recently publicized emergency events. This event data can be used to augment the events stored in the metadata database in order to keep the metadata database current with emerging risk or threat event types. The system 700 can also automatically extract data from the retrieved source data in order to populate the metadata database to identify and place events into sequences and group them by similar event sequences or category of events.

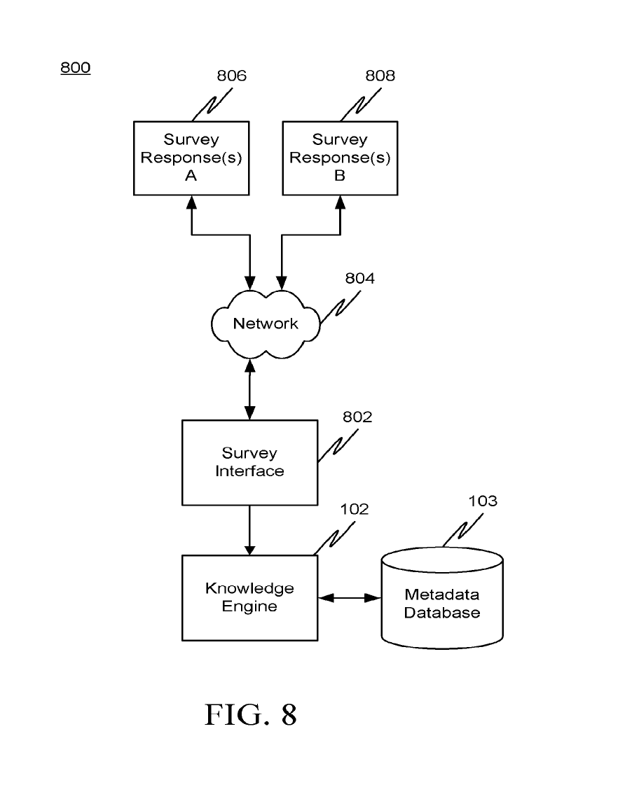

FIG. 8 is a diagram of a survey response acquisition system 800 in accordance with the present disclosure. The survey response acquisition system 800 can include a survey interface 802 coupled to the knowledge engine 102 and the metadata database 103. The survey interface can be adapted to receive survey results 806, 808 via a network 804. The network 804 can include any wired or wireless network such as a local area network (LAN), wide area network (WAN), the Internet, or the like. The survey results can be obtained via an online survey website, an email survey, a survey provided via a web service, or any other suitable survey mechanism.

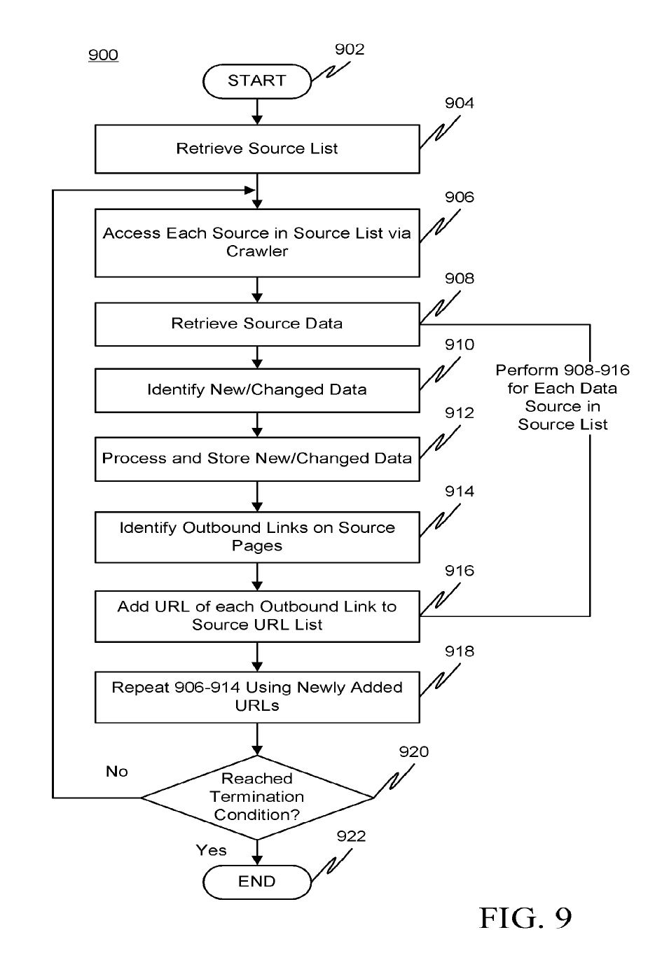

FIG. 9 is a chart showing a method of automatic data acquisition 900, in accordance with the present disclosure. Processing begins at 902 and continues to 904.

At 904, a data source list is retrieved. The source list can include URLs of data sources to be visited by a crawler, for example. The data sources can include news websites, government websites, or the like. Processing continues to 906.

At 906, the crawler accesses each source in the source list to retrieve source data 908 and identify new or changed data 910. Processing continues to 912.

At 912, new or changed data is processed and stored in the metadata database. The processing can include breaking an event down into its event path sequence, for example. Processing continues to 914.

At 914, optionally, any outbound links on a source page being crawled are identified. The outbound links can be to other pages within the same website or to pages of a different website. Processing continues to 916.

At 916, optionally, the URL of each identified outbound link can be added to the source URL list. Processing continues to 918.

At 918, optionally, 906 through 914 are repeated for the newly added URLs. Processing continues to 920.

At 920, a determination is made as to whether a termination condition has been reached. The termination condition can be defined in terms of running out of items on the list, crawl time, crawl depth (i.e., distance from root page), number of links away from original website, or the like. If yes, then processing continues to 922, where processing ends. If no, processing returns to 906.

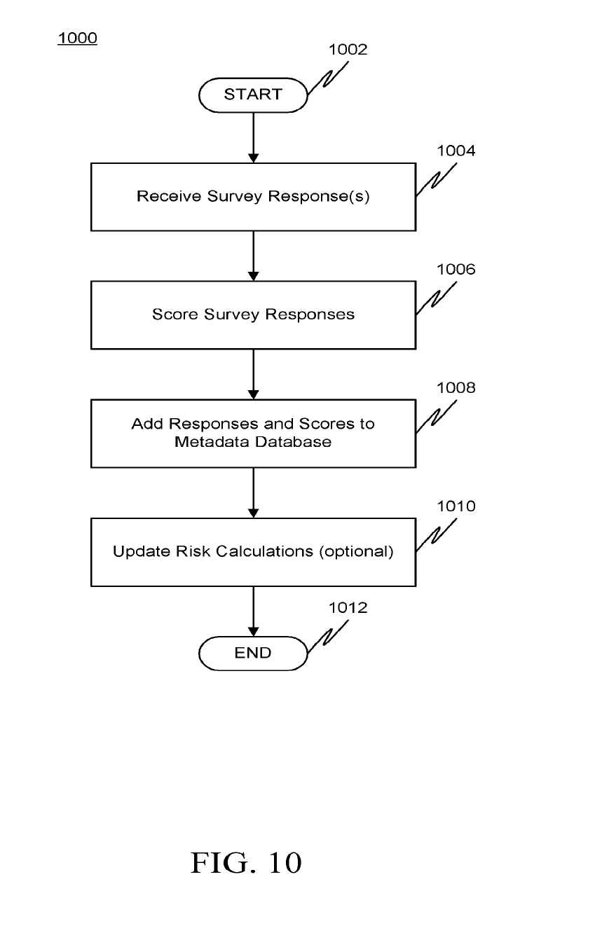

FIG. 10 is a chart showing a method of survey data acquisition 1000 in accordance with the present disclosure. Processing begins at 1002 and continues to 1004.

At 1004, one or more survey responses are received. The survey responses can be in the form of electronic data. Processing continues to 1006.

At 1006, the received survey responses are scored. Scoring allows for survey responses to be converted to quantified values. Processing continues to 1008.

At 1008, responses and scores are added to the metadata database. The survey responses and scores cause the metadata database to reflect a particular organization. Processing continues to 1010.

At 1010, optionally, risk calculations can be updated based on the survey results and scores. For example, if a survey of an organization indicates a deficiency with respect to a performance criteria that is important for preventing a threat, the risk calculation for that threat may be updated to reflect the fact that the organization has a deficiency (and therefore an increased risk) associated with that threat. Processing continues to 1012, where processing ends.

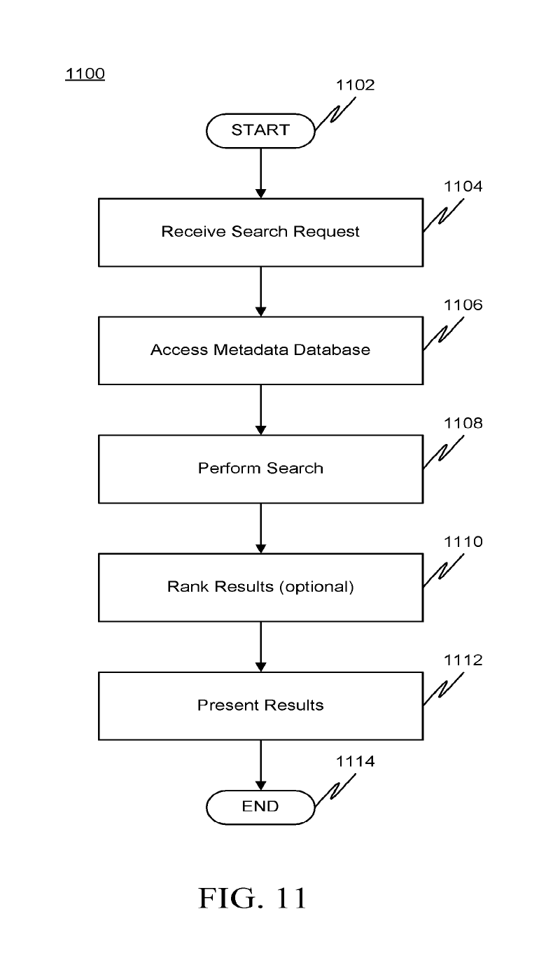

FIG. 11 is a chart showing a method of metadata database retrieval method 1100 in accordance with the present disclosure. In general, the metadata database structure permits dynamic comparing and contrasting of events, and grouping by event type or event sequence. Processing beings at 1102 and continues to 1104.

At 1104, a search request (or data retrieval request) is received. The data retrieval request can be for a number of data items such as threat assessments, standards, events, projected events, response information, or the like. The search can be directed to one or more specific fields within a record or to the entire metadata database. As mentioned above, the metadata database can be implemented as a flat-file database, which permits a search of all records without requiring any links between related tables commonly found in relational database systems. Processing continues to 1106.

At 1106, the metadata database is accessed and the search is performed at 1108. The search of the database can be performed using a database query, a search engine query, or any other suitable search technique. Processing continues to 1110.

At 1110, the results of the search are optionally ranked. The ranking can be according to any suitable attribute such as closeness to a search term, frequency of a search term, or the like. Processing continues to 1112.

At 1112, the results of the search are presented. The results can be presented in the form of a report or graphical visualization that is displayed on a display device and/or transmitted to another system. Processing continues to 1114, where processing ends.

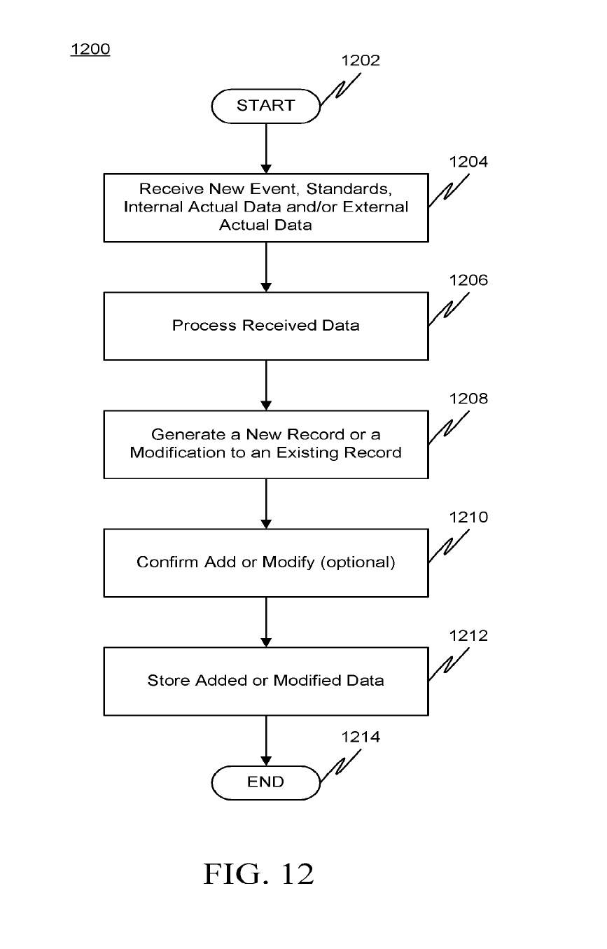

FIG. 12 is a chart showing a method for computerized learning 1200 in accordance with the present disclosure. Processing begins at 1202 and continues to 1204.

At 1204, new event data, standards, internal actual data and/or external actual data are received. Event data includes one or more of the event data elements discussed above in connection with FIG. 3. Standards data includes one or more of the data sources discussed above in connection with FIG. 4. Internal actual data includes data generated internally by the organization interacting with the metadata database. External actual data includes data generated by one or more organizations external to the organization interacting with the metadata database. These four types of new data represent four ways in which the metadata database is adapted to become a learning database.

As new event data becomes available, the metadata database can add the new event data to its existing collection of event data and, therefore, learn about changing threat scenarios and events. By acquiring new standards data, the metadata database can adapt to changing standards within the government or industry. Internal actual data can be used to refine the weighting or values of threat calculations based on the organization's experience. External data can also be used to refine the weighting or values of threat calculations based on the experience of external entities. Also, by acquiring new event data and reverse engineering the new events, the fidelity of initial risk calculations can dynamically increase as the population of reverse engineered events increases. Processing continues to 1206.

At 1206, the newly acquired data is processed (e.g., triangulated, normalized, or the like) in preparation for storing it into the metadata database. Processing continues to 1208.

At 1208, a new record can be generated or an existing record is modified. For example, in the case of a new event, a new event record may be generated. In the case of updated standards, an existing standard record may simply be updated and/or replaced with the new, updated standard. Processing continues to 1210.

At 1210, optionally, the new or modified record is confirmed. The optional confirmation can be useful in cases when the new or modified data needs to be verified by a person or other system. Processing continues to 1212.

At 1212, the newly added or modified record(s) are stored in the metadata database. Processing continues to 1214, where processing ends.

It will be appreciated that the modules, processes, systems, and sections described above can be implemented in hardware, hardware programmed by software, software instruction stored on a nontransitory computer readable medium or a combination of the above. For example, a system for computerized event assessment, projection and control of complex systems (e.g., 100 or 200) can be implemented, for example, using a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C++, C#.net or the like. The instructions can also comprise code and data objects provided in accordance with, for example, the Visual Basic™ language, or another structured or object-oriented programming language. The sequence of programmed instructions and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core). Also, the processes, modules, and sub-modules described in the various figures of and for embodiments above may be distributed across multiple computers or systems or may be co-located in a single processor or system. Exemplary structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any process capable of implementing the functions or steps described herein can be used to implement embodiments of the method, system, or a computer program product (software program stored on a nontransitory computer readable medium).

Furthermore, embodiments of the disclosed method, system, and computer program product may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the risk management and/or computer programming arts.

Moreover, embodiments of the disclosed method, system, and computer program product can be implemented in software executed on a programmed general purpose computer, a special purpose computer, a microprocessor, or the like.

It is, therefore, apparent that there is provided, in accordance with the various embodiments disclosed herein, computer systems, methods and software for metadata database management.

While the invention has been described in conjunction with a number of embodiments, it is evident that many alternatives, modifications and variations would be or are apparent to those of ordinary skill in the applicable arts. Accordingly, Applicants intend to embrace all such alternatives, modifications, equivalents and variations that are within the spirit and scope of the appended claims.

What is claimed is:

1. A computer-based system for managing a metadata database, the computer-based system comprising:
a processor coupled to a data storage device; and
an interface adapted to exchange data with another device,
the data storage device having stored thereon a metadata database having event data, a standards library, survey questions, survey answers, a survey scoring system and event response templates,
the data storage device also having software instructions stored thereon that, when executed by the processor, cause the processor to perform operations including:
automatically acquiring event data from a plurality of event data sources accessed via the interface;
storing the acquired event data in the metadata database;
automatically acquiring standards data from a plurality of standards data sources accessed via the interface;
storing the acquired standards data in the metadata database;
automatically acquiring survey response data and scoring the survey response data according to a scoring system retrieved from the metadata database in order to generate a survey score;
storing the acquired survey response data and the survey score in the metadata database;
updating risk values retrieved from the metadata database according to the acquired survey response data, and storing the updated risk values in the metadata database; and
providing a risk assessment output based on the updated risk values retrieved from the metadata database.

2. The computer-based system of claim 1, wherein the operations further include assigning a confidence score to the acquired event data, the confidence score being based on a source of the acquired data.

3. The computer-based system of claim 1, wherein the automatically acquiring event data and standards data includes using a crawler to access one or more websites over the Internet.

4. The computer-based system of claim 1, wherein the metadata database is configured as a flat-file database.

5. The computer-based system of claim 4, wherein the flat-file database is configured to have records with a variable number of fields, each field of variable length.

6. The computer-based system of claim 1, wherein the operations further include calculating, using the processor, a risk value based on the event data and scored survey response data.

7. A computerized method for metadata database management, the method comprising:
acquiring, at a processor, event data from a plurality of event data sources accessed via an interface configured to connect the processor to an external system;
storing the acquired event data in a metadata database coupled to the processor;
acquiring, at the processor, standards data from a plurality of standards data sources accessed via the interface;
storing the acquired standards data in the metadata database;
acquiring, at the processor, survey response data and scoring the survey response data according to a scoring system retrieved from the metadata database in order to generate a survey score;
storing the acquired survey response data and the survey score in the metadata database;
updating risk values retrieved from the metadata database according to the acquired survey response data, and storing the updated risk values in the metadata database; and
providing a risk assessment output based on the updated risk values retrieved from the metadata database.

8. The method of claim 7, further comprising assigning a confidence score to the acquired event data, the confidence score being based on a source of the acquired data.

9. The method of claim 7, wherein the automatically acquiring event data and standards data includes using a crawler to access one or more websites over the Internet.

10. The method of claim 7, wherein the metadata database is configured as a flat-file database.

11. The method of claim 10, wherein the flat-file database is configured to have records with a variable number of fields, each field configured to store data of a variable length.

12. The method of claim 7, further comprising calculating, using the processor, a risk value based on the event data and scored survey response data.

13. A computerized control system for continuous control of a learning metadata database, the computerized control system comprising:
a processor having an information processing unit and a computer readable medium;
a metadata database coupled to the processor, the metadata database being adapted to store event risk assessment, projection and control information;
an interface coupled to the processor and adapted to connect the processor to a computer network,
the computer readable medium storing instructions that, when executed by the processor, cause the processor to perform operations including:
acquiring event data from a plurality of event data sources accessed via the interface;
storing the acquired event data in the metadata database;
acquiring standards data from a plurality of standards data sources accessed via the interface;
storing the acquired standards data in the metadata database;
acquiring survey response data and scoring the survey response data according to a scoring system retrieved from the metadata database in order to generate a survey score;
storing the acquired survey response data and the survey score in the metadata database;
updating risk values retrieved from the metadata database according to the acquired survey response data, and storing the updated risk values in the metadata database; and
providing a risk assessment output based on the updated risk values retrieved from the metadata database.

14. The control system of claim 13, wherein the operations further include assigning a confidence score to the acquired event data, the confidence score being based on a source of the acquired data.

15. The control system of claim 13, wherein the automatically acquiring event data and standards data includes using a crawler to access one or more websites over the Internet.

16. The control system of claim 13, wherein the metadata database is configured as a flat-file database.

17. The control system of claim 16, wherein the flat-file database is configured to have records with a variable number of fields, each field of variable length.

18. The control system of claim 13, wherein the operations further include calculating, using the processor, a risk value based on the event data and scored survey response data.
